(19) United States
(12) Patent Application Publication
(10) Pub. No.: US 2008/0279755 A1
(43) Pub. Date: Nov. 13, 2008

(54) Carbon Nanotube, Nanorod, Nanosphere, and Related Nanostructure Formation Using Metal Boride Catalysts

(75) Inventor: James T. Spencer, Fayetteville, NY (US)

Correspondence Address: BOND, SCHOENECK & KING, PLLC, ONE LINCOLN CENTER, SYRACUSE, NY, 13202-1355, US

(73) Assignee: SYRACUSE UNIVERSITY, Syracuse, NY (US)

(21) Appl. No.: 11/774,237

(22) Filed: Jul. 6, 2007

Related U.S. Application Data
(60) Provisional application No. 60/806,640, filed on Jul. 6, 2006.

(51) Int. Cl. C01B 31/02; D01F 9/12

(52) U.S. Cl. 423/447.3; 423/445 R; 977/742; 977/734

(57) ABSTRACT

The present invention relates to nanostructures such as carbon nanotubes, nanorods, and nanospheres and, more specifically, to a system and method for forming such nanostructures through the use of metal boride catalysts.

### CROSS-REFERENCE TO RELATED APPLICATIONS

The present application claims priority to U.S. Provisional Application No. 60/806,640, filed on Jul. 6, 2006.

### BACKGROUND OF THE INVENTION

1. Field of Invention

The present invention relates to nanostructures such as carbon nanotubes, nanorods, and nanospheres and, more specifically, to a system and method for forming such nanostructures through the use of metal boride catalysts.

2. Description of Prior Art

Carbon nanostructures, such as nanotubes and nanorods, potentially have significant applications across a wide range of technological areas with uses ranging from strengthened composite materials to field-effect transistors and electronic circuitry. (A. Bachtold et al., “Logic Circuits with Carbon Nanotube Transistors,” Science 2001, 294, 1317, hereby incorporated by reference in its entirety). One of the historic limitations on their use, however, has been the availability of controlled synthetic pathways to prepare the designed nanoscale carbon-based materials efficiently and inexpensively. A variety of methods have been discovered to prepare carbon nanotubes, but all apparently suffer from varying difficulties that often include low yields, unacceptable impurity levels, require high energy processes, provide a lack of sufficient compositional control, and others. (Kalpana Awasthi et al., “Synthesis of Carbon Nanotubes,” J. Nanosci. Nanotech. 2005, 5, 1616; M. Terrones, “Carbon Nanotubes: Synthesis and Properties, Electronic Devices and Other Emerging Applications,” Internatl. Materials Rev., 2004, 49, 325; Jie Liu et al., “Recent Advances in Methods of Forming Carbon Nanotubes,” MRS Bull., 2004, 29, 244, hereby incorporated by reference in their entirety). Recently, techniques employing CVD, aerosol and catalytic methods have been investigated in carbon nanotube formation. (M. Pinault et al., “Carbon Nanotubes Produced by Aerosol Pyrolysis: Growth Mechanisms and Post-Annealing Effects,” Diamond Rel. Mater., 2004, 13, 1266, hereby incorporated by reference in its entirety). A variety of catalysts have been used, including metal cyclopentadienyl and other organometallic complexes, in this approach. Notwithstanding, there is a need for an improved method of preparation of carbon nanostructures, which is efficient and inexpensive and overcomes the varying difficulties in the prior art, as noted supra.

### SUMMARY OF THE INVENTION

In accordance with an embodiment of the present invention, nanostructures such as carbon nanotubes, nanorods, and nanospheres and, more specifically, a system and method for forming such nanostructures through the use of metal boride catalysts, are provided.

In accordance with an embodiment of the present invention, a system and method for forming carbon nanostructures comprising metal boride catalysts, both as pre-formed particles and those prepared in situ from precursor compounds, are provided. As disclosed herein, the use of these metal boride catalysts have been found to be highly efficient systems for nanotube, nanorod, and nanosphere formation with controllable morphologies. Further, as disclosed herein, these boride-based systems have significant advantages over other reported approaches including their ready availability, relative low cost, high nanotube, nanorod, and nanosphere formation efficiency, and relative morphological control of the produced materials.

### BRIEF DESCRIPTION OF THE DRAWINGS

The present invention will be more fully understood and appreciated by reading the following Detailed Description in conjunction with the accompanying drawings, in which:

FIG. 1 shows SEM photomicrographs of carbon nanorods prepared from preformed metal boride particles according to an embodiment of the present invention.

FIG. 2 shows TEM and SEM photomicrographs of carbon nanotubes formed from aerosol methods employing boron source compounds according to an embodiment of the present invention.

FIG. 3 is a graphical illustration of a powder XRD of carbon nanotubes as shown in FIG. 2 according to an embodiment of the present invention.

FIG. 4a is a SEM photomicrograph of carbon nanospheres formed from BH₃.THF, TiC₄, and THF on a mild steel substrate according to an embodiment of the present invention.

FIG. 4b is a SEM photomicrograph of carbon nanotubes with some nanospheres formed from BH₃.THF, TiC₄, and THF on a mild steel substrate according to an embodiment of the present invention.

### DETAILED DESCRIPTION

In accordance with an embodiment of the present invention, carbon nanostructures such as carbon nanotubes, nanorods, and nanospheres through to micron-sized structures, have been efficiently synthesized by several novel methods involving the use of boron and metal boride-containing compounds, as described in the Examples that follow.

In accordance with an embodiment of the present invention, using aerosol and related techniques that employ either metal boride catalysts or precursors to metal boride materials, carbon nanotubes, nanorods, and nanospheres can be efficiently prepared in relatively large quantities and high purities.

Advantages of the invention are illustrated by the following Examples. However, the particular materials and amounts thereof recited in these examples, as well as other conditions and details, are to be interpreted to apply broadly in the art and should not be construed to unduly restrict or limit the invention in any way.

The physical measurements obtained and discussed in the following Examples were performed by the following instruments: Scanning electron micrographs (SEM) were obtained on a Jeol JSM 5800lv, and the transmission electron micrographs (TEM) on a Jeol 2000EX instrument in the N.C. Brown Center for Ultrastructure Studies of the S.U.N.Y. College of Environmental Science and Forestry, Syracuse, N.Y. X-ray Spectra (EDAX) were obtained on a Kevex 7500 Microanalyst System. The X-ray diffraction patterns (XRD) were recorded on a Brucker D8 powder diffractometer in the Syracuse University Chemistry Department. Copper K_{α} radiation and a graphite single crystal monochromator were employed in the measurements reported herein.

The solvents used in the following Examples were of dried reagent grade or better. The nido-decaborane(14), B₁₀H₁₄, was purchased from the Callery Chemical Company and was purified by vacuum sublimation at 40° C. prior to use. The anhydrous (99.9%) neodymium(III) chloride (NdCl₃) and cobalt(II) chloride (CoCl₂) were commercially available (Cerac, Inc.) and were used as received and handled under an inert atmosphere. All other reagents were obtained from the Aldrich Chemical Company, and were used as received.

### EXAMPLE 1

This example describes a system and method for synthesizing carbon nanostructures according to an embodiment of the present invention. The approach described herein uses pre-formed metal boride particles (such as titanium boride) that range in size from the micron to the nanometer scales. These particles are prepared by aerosol (ca. 1 micron), solution (20 to 300 nanometers), or mechanical methods (multimicron), depending upon the desired particle size. (the general technique aspects should be appreciated by those skilled in the art, see, e.g., J. D. Caruso, III, Ph.D. Dissertation, Syracuse University, 2004, hereby incorporated by reference in their entirety).

Briefly, particles of metal borides were prepared from the reaction of metal salts and NaBH₄. For example, in this process, the metals salt (25 mL of 0.27 M) is dissolved in water and an aqueous solution of the NaBH₄ solution (25 mL of 2 M) is slowly added to the metal-containing solution at 0 C (also works well at room temperature). The metal boride precipitates from the aqueous solution. The boride was dried at 120° C. and then annealed in vacuo at 600° C. for 18 hr. The powder was confirmed to be the metal boride material by powder XRD analysis. This process has worked successfully for a variety of representative metals including Ni, Co, Fe, Cu, and many others.

A pre-formed powder of micro- or nano-sized titanium boride particles, obtained from the preparation procedure outlined supra, was adhered onto a substrate and placed into a hot reaction zone of a quartz tube furnace. (the general technique aspects should be appreciated by those skilled in the art, see, e.g., J. D. Caruso, III, Ph.D. Dissertation, Syracuse University, 2004; R. L. Axelbaum et al., “Wet Chemistry and Combustion Synthesis of Nanoparticles of TiB₂,” Nanostructured Mater, 1993, 2, 139; C. Kapfenberger et al., Solid State Sciences, 2003, 5, 925-930, hereby incorporated by reference in their entirety). The furnace was then heated at ca. 900° to 1000° C., and an aerosol/vapor stream of organic solvent, such as acetonitrile, was injected into the thermal reaction zone and was allowed to flow through the reaction chamber over the boride bed. After the reaction, the substrate and furnace were cooled to room temperature and examined by SEM and TEM (similar to Example 2, as discussed infra).

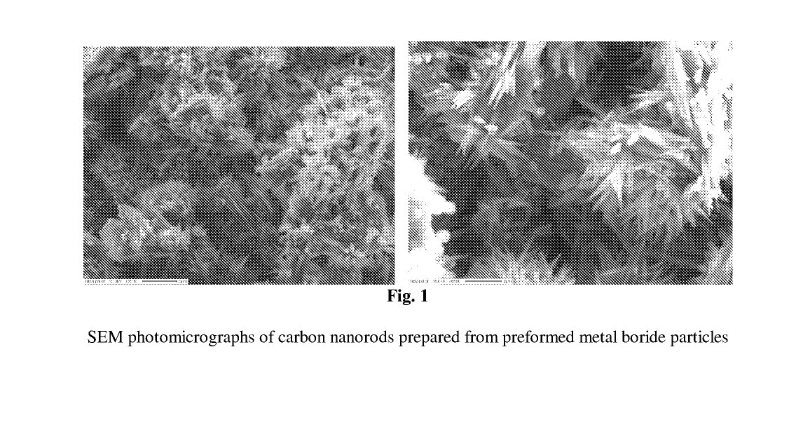

As shown in FIG. 1, carbon nanorods and nanotubes were found by electron microscopy to abundantly grow from the particulate boride materials. These carbon nanorods and nanotubes were found to completely coat the boride catalytic centers (this was found to depend upon the morphology of the metal boride initially employed). If the boride particles were either tightly packed together or a dense coating of the metal boride was employed, nanorods with sizes ranging from several hundred nm to ca. 1 micron in diameter were observed and with varying lengths up to 100 microns. Elemental analysis, EDAX, and XRD showed these to be carbon nanorods and metal boride whisker materials. Samples of the rods were removed from the particles and were found to be uncontaminated by metal.

### EXAMPLE 2

This example describes a method for forming nanotubes which employs the aerosol pyrolysis of a solution containing a boron source compound and a soluble metal source in an organic solvent. In particular, the nanotubes were synthesized by the pyrolysis of a solution containing a boron source—decaborane (14)—as well as titanium tetrachloride and acetonitrile. Other boron sources, such as BH₃.THF, BMe₃, or B(OR)₃ and the like, could be used.

All reagents were used without any further purification. 0.100 gram (0.0008 mol) of decaborane (Alfa Aesar) was dissolved in 100 mL of HPLC grade acetonitrile (Fisher) in a 250 ml Erlenmeyer flask that was hooked up to a constant flow of Argon gas. Then 3.0 mL (0.009 mol) of titanium tetrachloride (99.9%, Aldrich) was added using a syringe. A yellow precipitate formed immediately upon addition of the titanium tetrachloride. The precipitate was redissolved to form a homogenous solution by stirring or swirling of the flask. The solution was then pumped into the ultrasonic chamber using a Manostat (#72-410-014) peristaltic pump.

An aerosol of the solution, with an approximate particle size of 1.7 microns, was generated by an ultrasonic nebulizer (Model 241, 2.4 MHz, SONAER). The particles were then carried (aerosol was injected) into a pre-heated quartz tube (flow aerosol tube furnace) by a moderate flow of an argon gas stream (or dry nitrogen stream). The tube furnace was heated between 900 to 940° C. (preferably heated and held at 900° C.). Pyrolysis takes about 3 hours or until all of the solution has been consumed. The furnace and the tube were slowly cooled to room temperature.

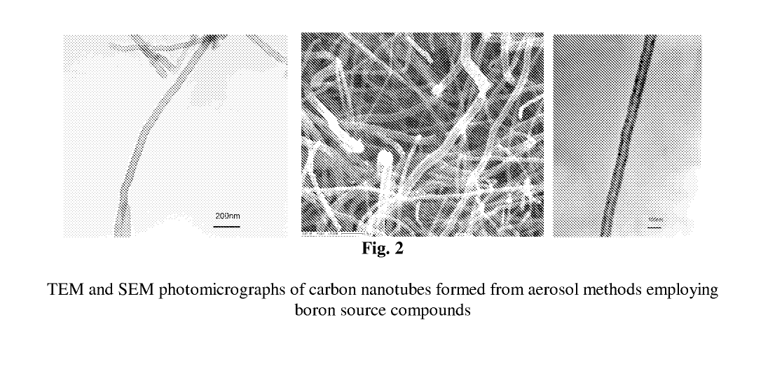

The results show that small gray-black nodules were observed on the surface of the walls of the quartz tube furnace. The nodules were characterized (as generated using SEM and TEM) to be composed of pure carbon nanotubes. TEMs for a typical nanotube prepared by this technique are shown in FIG. 2. In order to obtain the SEM and TEM analyses, a colloidal suspension was made by taking two or three nodules off from the quartz tube and roughly grinding the nodules in an agate mortar and pestle with 5-10 mL of absolute ethanol (Pharmco). The suspension was dropped onto a formvar coated copper grid and air-dried.

The results also showed that the nanotubes were remarkably well formed with a very large aspect ratio (tube diameter ca. 75-100 nm with lengths approaching mm dimensions).

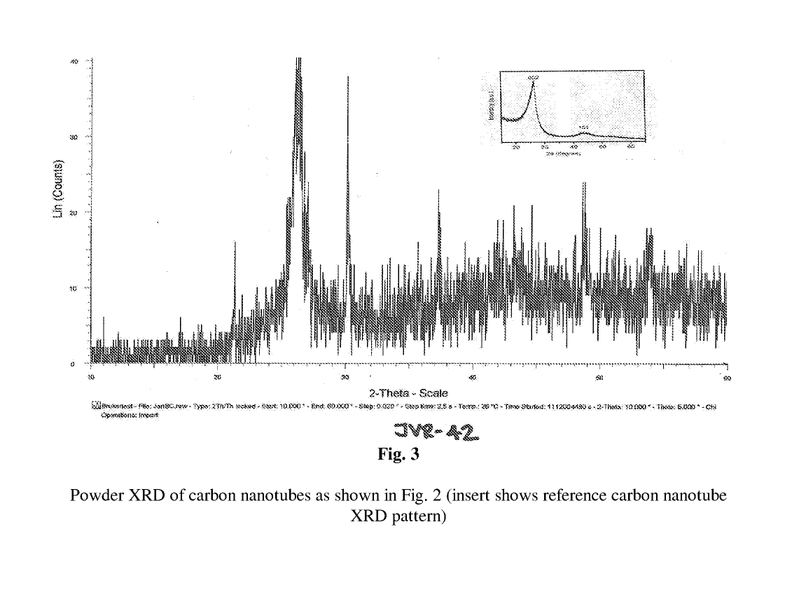

As illustrated in FIG. 3, elemental analysis, EDAX and XRD, again showed these to be carbon nanotubes that were uncontaminated by metal. (the general technique aspects should be appreciated by those skilled in the art, see e.g., Zou, et al. Inorg. Chem. 2004, 43, 5433, hereby incorporated by reference in their entirety).

These Examples represent novel methods for the formation of nanotube materials, i.e., the formation of these nanotube materials from boride catalytic methods. Other boron source compounds, beside decaborane, are also able to prepare the carbon nanotubes as well as a range of metals, such as nickel boride, neodymium boride, iron boride and the like.

### EXAMPLE 3

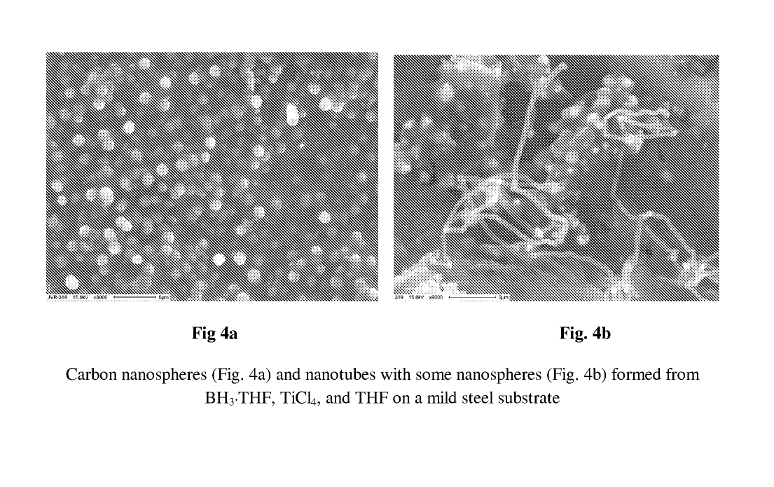

This example illustrates that changing the source compounds, and particularly the substrate upon which the structures form, were found have a significant impact upon the displayed morphologies. For example, running the aerosol process employing a mild steel substrate lead to a mixture of carbon nanotubes and nanospheres, as shown in FIGS. 4a-4b.

In this example, BH₃.THF (40 mL of a 1.0 M THF solution) and TiCl₄ (2 mL) were dissolved in anhydrous THF and diluted to 100 mL total volume under an inert atmosphere. This solution was passed via an inert gas carrier into the hot zone of a quartz hot-walled reactor that contained a clean mild steel substrate. The furnace was maintained between 9000 and 1000° C. during the entire reaction. The entire 100 mL of solution was passed through the reactor within ca. 1 hr. The furnace was then allowed to slowly cool to room temperature and the steel substrate removed from the reactor in the air. The surface of the steel was coated with a reflective material that ranged from light gray to silvery. SEM analysis showed that the light gray material contained carbon nanotubes while the silvery region consisted of carbon nanospheres (FIGS. 4a-4b). Interestingly, the unique carbon nanospheres were remarkably uniform in structure and diameter.

In accordance with an embodiment of the present invention, the novel methods illustrated by the Examples described supra, show very efficient production of carbon nanostructures including carbon nanotubes, nanorods and nanoshperes.

These novel methods have broad applications and are directly and logically extendable to related synthetic pathways. For example these novel methods are extendable to the: (1) use of a metal boride thin film or coating as the substrate for direct nanostructure formation; (2) preparation of discrete metal boride nanospheres (e.g., using the previously discovered aerosol technique or solution formation methods using metal salts and NaBH₄) and then either spread or embed these particles in a surface (e.g., BC, thermally stable polymer, metallic alloy, etc.). This prepared metal boride surface would be used in the catalytic nanostructure formation; (3) use of the boride catalysts in a bed reactor system to continuously prepare the nanostructures; (4) use of other boron and metal precursors compounds; (5) use of other metal boride phases and alloys as catalysts; and (6) embedding of boride materials in ceramics, glasses, alloys or other substrates to prepare robust boride catalytic surfaces for use in flow processes.

The present invention offers several novel techniques employing boron compounds that have been discovered for the formation of carbon nanotubes, nanorods, and nanospheres through to micron-sized structures. The formed structures were shown to range in size from ca. 75 nm to 1 micron in diameter and up to 100 microns in length. The techniques are low cost, show high nanotube, nanorod, and nanosphere formation efficiency and purity, and exhibit relative morphological control of the produced materials.

While several embodiments of the invention have been discussed, it will be appreciated by those skilled in the art that various modifications and variations of the present invention are possible. Such modifications do not depart from the spirit and scope of the invention.

What is claimed is:

1. A method of forming carbon nanostructures, comprising the steps of:
preparing metal boride catalysts;
positioning said metal boride catalysts inside a furnace;
heating said furnace to between 900 and 1000° C.;
flowing aerosol vapors of an organic solvent over said metal boride catalysts inside said furnace; and
cooling said furnace and said metal boride catalysts to room temperature, wherein said nanostructures are formed on a surface of said metal boride catalysts.

2. The method of claim 1, wherein said metal boride catalysts comprise metal boride particles comprising titanium boride.

3. The method of claim 1, further comprising the step of adhering said metal boride catalysts to a substrate before said positioning step.

4. The method of claim 3, wherein said step of positioning further comprises the step of positioning said substrate into a thermal reaction zone of said furnace.

5. The method of claim 1, wherein said furnace comprises a quartz tube furnace.

6. The method of claim 1, wherein said organic solvent comprises acetonitrile.

7. The method of claim 1, wherein said nanostructures comprise nanostructures selected from the group consisting of nanotubes, nanorods, and nanospheres.

8. The method of claim 1, further comprising the step of examining said substrate by an instrument wherein said instrument is selected from the group consisting of a scanning electron micrograph, transmission electron micrograph, X-ray spectrometer, and X-ray diffractor.

9. The method of claim 1, further comprising the step of removing a sample of said nanostructures from said metal boride catalysts.

10. The method of claim 1, wherein said step of preparing further comprises the steps of:
adding an aqueous solution of NaBH₄ solution to a solution of a metal salt dissolved in water;
precipitating a metal boride from said aqueous solution;
drying said metal boride; and
annealing said metal boride to form said metal boride catalyst.

11. The method of claim 10, further comprising the step of confirming said metal boride catalyst by X-ray diffraction.

12. The method of claim 10, wherein said metal of said metal boride catalyst comprises a metal selected from the group consisting of Ni, Co, Fe, and Cu.

13. A method of forming carbon nanostructures by aerosol pyrolysis of a solution comprising a boron source compound and a metal source compound in an organic solvent, comprising the steps of:
dissolving said boron source compound in said organic source within a container connected to a flow of Argon gas;
adding said metal source compound to said container to form a precipitate;
forming a homogenous solution by redissolving said precipitate within said container;
generating an aerosol of said solution;
preheating a quartz tube furnace to between 900 and 1000° C.;
injecting said aerosol into said furnace by a flow of a gas stream; and
cooling said furnace to room temperature following pyrolysis of said solution, wherein said nanostructures are formed on a surface of walls of said quartz tube.

14. The method of claim 13, wherein said carbon nanostructures comprise nanostructures selected from the group consisting of nanotubes, nanorods and nanospheres.

15. The method of claim 13, wherein said boron source compound comprises a boron source selected from the group consisting of decaborane (14), BH₃.THF, BMe₃, and B(OR)₃.

16. The method of claim 13, wherein said metal source compound comprises titanium tetrachloride.

17. The method of claim 13, wherein said gas stream comprises a gas stream selected from the group consisting of argon and dry nitrogen.

18. The method of claim 13, further comprising the step of examining said nanostructures by an instrument wherein said instrument is selected from the group consisting of a scanning electron micrograph, transmission electron micrograph, X-ray spectrometer, and X-ray diffractor.

19. The method of claim 13, wherein said organic solvent comprises acetonitrile.

20. A method of forming carbon nanostructures by aerosol pyrolysis of a solution comprising the steps of:
dissolving BH₃.THF and TiCl in anhydrous THF to form said solution;
heating a quartz hot-walled furnace to between 900 and 1000° C.;
passing said solution via an inert gas carrier into a hot zone of said quartz hot-walled furnace comprising a mild steel substrate; and
cooling said furnace to room temperature, wherein said nanostructures are formed on a surface of said steel substrate.

21. The method of claim 20, wherein said nanostructures comprise nanostructures selected from the group consisting of nanotubes, nanorods and nanospheres.

22. The method of claim 20, further comprising the steps of removing said steel substrate from said furnace and analyzing said nanostructures by an instrument wherein said instrument is selected from the group consisting of a scanning electron micrograph, transmission electron micrograph, X-ray spectrometer, and X-ray diffractor.

23. A carbon nanostructure formed by the method of claim 1.

24. A carbon nanostructure formed by the method of claim 13.

25. A carbon nanostructure formed by the method of claim 20.
